(19) United States
(12) Patent Application Publication
(10) Pub. No.: US 2026/0244071 A1
(43) Pub. Date: Aug. 20, 2026

(54) CONFIGURING WINDOW-MOUNTED PHOTONIC INTEGRATED CIRCUITS

(71) Applicant: Analog Photonics LLC, Boston, MA (US)

(72) Inventors: Jingda Wu, Everett, MA (US); Michael Robert Watts, Hingham, MA (US)

(73) Assignee: Analog Photonics LLC, Boston, MA (US)

(21) Appl. No.: 19/544,268

(22) Filed: Feb. 19, 2026

Related U.S. Application Data
(60) Provisional application No. 63/760,887, filed on Feb. 20, 2025.

(51) Int. Cl. G02F 1/295

(52) U.S. Cl. CPC G02F 1/2955

(57) ABSTRACT

An apparatus comprises: a photonic integrated circuit comprising a surface that is substantially coplanar with a first plane, and an aperture in proximity to the surface, where the aperture has an associated area; a window comprising an inner surface and an outer surface; and a coating formed on a portion of or from a portion of the outer surface of the window, where an area of the coating is less than twice the area of the aperture; wherein the surface of the photonic integrated circuit is mounted in proximity to a portion of the inner surface of the window such that the first plane is parallel to a tangent plane of the portion of the inner surface of the window within an angle of tolerance of less than or equal to 20 degrees.

### CROSS-REFERENCE TO RELATED APPLICATION(S)

This application claims the benefit of and priority to U.S. Provisional Application Ser. No. 63/760,887, entitled “CONFIGURING WINDOW-MOUNTED PHOTONIC INTEGRATED CIRCUITS,” filed Feb. 20, 2025, which is incorporated herein by reference.

### TECHNICAL FIELD

This disclosure relates to configuring window-mounted photonic integrated circuits.

### BACKGROUND

Some light detection and ranging (LiDAR) systems optimize various aspects of the LiDAR configuration based on different criteria. An optical wave is transmitted from an optical source to target object(s) at a given distance and the light backscattered from the target object(s) is collected. Some LiDAR systems can include photonic integrated circuits (PICs) comprising optical phased arrays (OPAs). Some OPAs used in such systems have a linear distribution of emitter elements (also called emitters or antennas or optical antenna elements). Steering about a first axis perpendicular to the linear distribution can be provided by changing the relative phase shifts in phase shifters feeding each of the emitter elements. Other techniques can be used for steering about a second axis orthogonal to the first axis. The optical source used in such a system is typically a laser, which provides an optical wave that has as narrow linewidth and has a peak wavelength that falls in a particular range (e.g., between about 100 nm to about 1 mm, or some subrange thereof), also referred to herein as simply “light.” Some LiDAR systems can be mounted within a cabin of a vehicle or to a window of a vehicle such that the LiDAR system can be used to sense the presence of objects outside of the vehicle. In some examples, a window can be a windshield of a vehicle.

### SUMMARY

In one aspect, in general, an apparatus comprises: a photonic integrated circuit comprising a surface that is substantially coplanar with a first plane, and an aperture in proximity to the surface, where the aperture has an associated area; a window comprising an inner surface and an outer surface; and a coating formed on a portion of or from a portion of the outer surface of the window, where an area of the coating is less than twice the area of the aperture; wherein the surface of the photonic integrated circuit is mounted in proximity to a portion of the inner surface of the window such that the first plane is parallel to a tangent plane of the portion of the inner surface of the window within an angle of tolerance of less than or equal to 20 degrees.

Aspects can include one or more of the following features.

The aperture is in proximity to a first set of optical antenna elements formed in a first layer of the photonic integrated circuit and a second set of optical antenna elements formed in a second layer of the photonic integrated circuit that is different than the first layer.

The first set of optical antenna elements and the second set of optical antenna elements are configured to perturb one or more optical waves propagating in a set of waveguides formed in the photonic integrated circuit such that an optical phased array formed in the photonic integrated circuit is configured to transmit a beam to, or receive a beam from, a target location through the aperture.

At least one of (1) a pitch of the first set of optical antenna elements and a pitch of the second set of optical antenna elements or (2) a wavelength of the one or more optical waves is configured such that the beam is steered within a field of view having a center that is less than 70 degrees relative to the first plane.

The window is a component of a vehicle.

The window is a windshield of the vehicle.

The vehicle is selected from a group consisting of an automobile, a truck, a bus, a train, a plane, and a boat.

The window is angled relative to a direction of travel associated with the vehicle such that the direction of travel is less than 70 degrees relative to the tangent plane.

The photonic integrated circuit comprises an optical phased array configured to transmit a beam to, or receive a beam from, a target location through the aperture, such that the beam is steered within a field of view having a center that is less than 20 degrees relative to the direction of travel.

The angle of tolerance is less than or equal to 10 degrees.

The apparatus further comprises an index-matching material between the surface of the photonic integrated circuit and the portion of the inner surface of the window, where the index-matching material has an index of refraction that matches an index of refraction of the window within 10%.

The coating comprises an anti-reflective coating comprising one or more layers of material configured to reduce reflections from the outer surface of the window.

The one or more layers of material comprise at least one nanostructured layer of the portion of the outer surface of the window.

The portion of the inner surface of the window is in proximity to the portion of the outer surface of the window on which the coating is formed.

At least one of: (1) the aperture is configured to transmit at least one beam of an optical wave toward a target location, or (2) the aperture is configured to receive at least one beam of an optical wave from a target location.

In another aspect, in general, a method comprises: providing a photonic integrated circuit comprising a surface that is substantially coplanar with a first plane, and an aperture in proximity to the surface, where the aperture has an associated area; and mounting the photonic integrated circuit to a portion of an inner surface of a window such that the surface of the photonic integrated circuit is in proximity to a portion of the inner surface of the window and the first plane is parallel to a tangent plane of the portion of the inner surface of the window within an angle of tolerance of less than or equal to 20 degrees; wherein a coating is formed on a portion of or from a portion of an outer surface of the window such that an area of the coating is less than twice the area of the aperture.

Aspects can include one or more of the following features.

At least one of: (1) the aperture is configured to transmit at least one beam of an optical wave toward a target location, or (2) the aperture is configured to receive at least one beam of an optical wave from a target location.

The angle of tolerance is less than or equal to 10 degrees.

The aperture is in proximity to a first set of optical antenna elements formed in a first layer of the photonic integrated circuit and a second set of optical antenna elements formed in a second layer of the photonic integrated circuit that is different than the first layer.

The window is a component of a vehicle.

Aspects can have one or more of the following advantages.

Some vehicle windows comprise coatings to reject infrared (IR) light to avoid warming up the cabin under sunlight. However, some implementations of LiDAR systems are configured to detect IR lasers having optical wavelengths of 940 nm, 1310 nm, 1550 nm, or wavelength bands comprising these optical wavelengths, to reach the safety limit of human eyes. Furthermore, some windows are placed at a steep angle in respect to the LiDAR detection angle, which can reduce the photon transmission. In some examples, anti-reflection (AR) coatings are used on the windshield to improve the LiDAR detection efficiency. Without using the methods disclosed herein, some LiDAR systems can be associated with a large projection of an aperture of the LiDAR system on a window, which can be associated with a large AR coating area.

In contrast, using the methods disclosed herein, an aperture of a LiDAR system can be configured to reduce the projected aperture size on the window and thus lower the cost of an AR coating associated with the aperture. In some implementations, an aperture of a LiDAR system can be aligned with a surface of the window and allow for a much smaller output aperture on the window that is similar to the size of the aperture itself. In some examples, configuring a LiDAR system can reduce the size of an associated AR coating area while preserving the structural integrity and aesthetic design of the window.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1D are schematic diagrams of example LiDAR systems mounted to windows.

FIG. 1E is a prophetic plot of numerical simulations associated with a LiDAR system.

FIG. 2 is a schematic diagram of an example of a LiDAR system.

FIG. 3A is a schematic diagram of an example of an optical phased array.

FIG. 3B is a schematic diagram of an example of an optical switched array.

FIG. 3C is a schematic diagram of an example of an optical switched array system.

FIG. 4A-4B are schematic diagrams of an example of a grating-antenna-based optical phased array.

FIG. 5 is a schematic diagram of an example of angular steering associated with radiation intensity patterns for optical phased arrays.

FIGS. 6A-6B are schematic diagrams of example LiDAR configurations.

FIGS. 7A-7B are schematic diagrams of example LiDAR configurations.

FIGS. 8A-8B are schematic diagrams of example LiDAR configurations.

FIGS. 9A-9C are schematic diagrams of example configurations of windows and photonic integrated circuits.

FIG. 10 is a flowchart of an example method associated with configuring window-mounted photonic integrated circuits.

### DETAILED DESCRIPTION

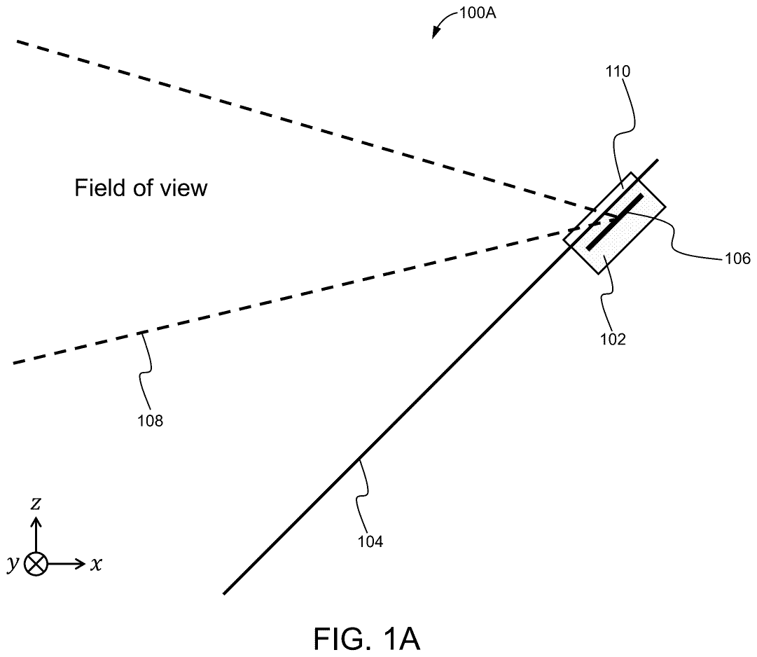

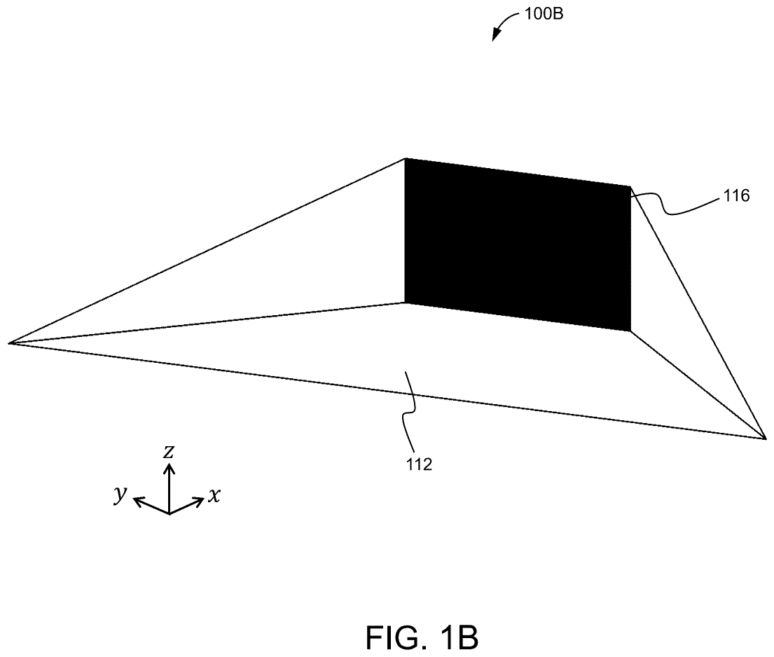

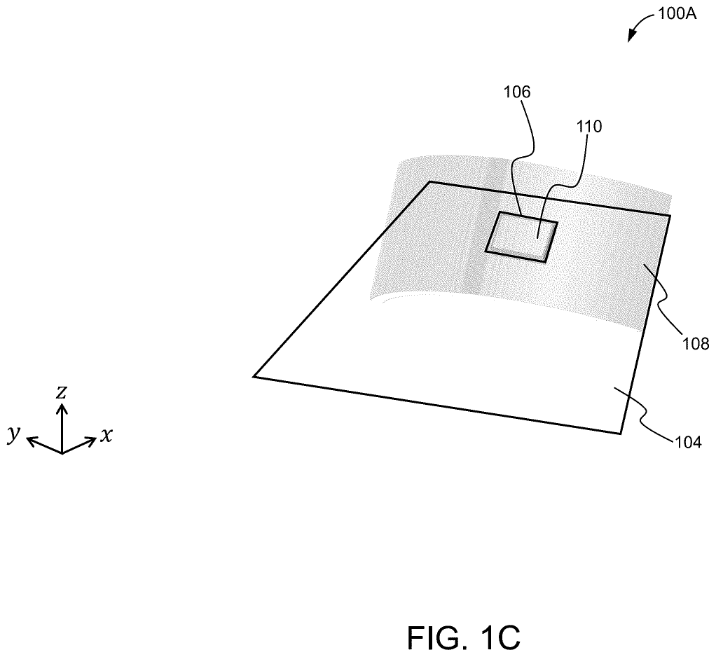

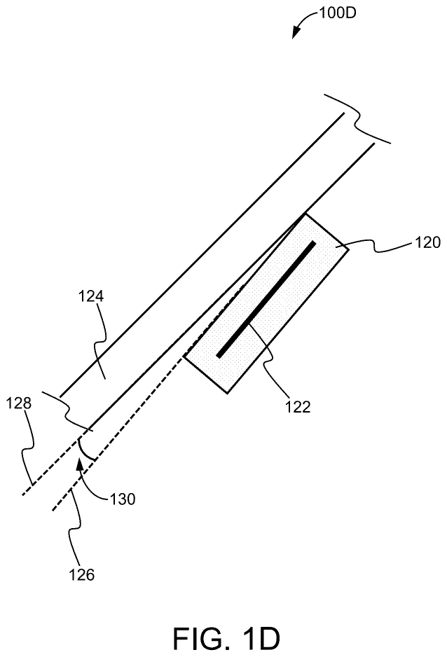

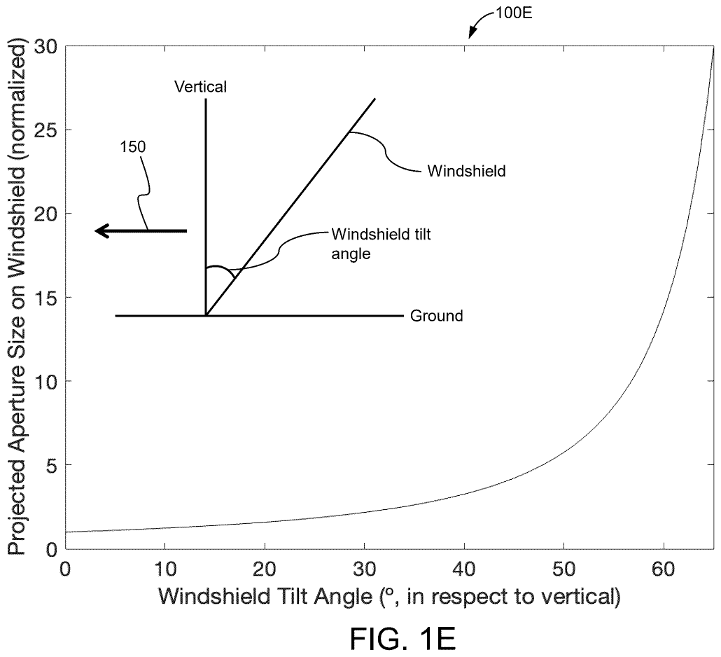

FIG. 1A depicts a side view of an example configuration 100A that includes a LiDAR system, i.e., an apparatus, comprising a photonic integrated circuit 102 mounted to a portion of an inner surface of a window 104 near the top of the window 104. The photonic integrated circuit 102 comprises an aperture 106 that is in proximity to a surface of the photonic integrated circuit 102, where the surface is substantially coplanar with a first plane. The photonic integrated circuit 102 is mounted such that the surface of the photonic integrated circuit is mounted in proximity to a portion of the inner surface of the window 104. Furthermore, the photonic integrated circuit 102 is mounted such that the first plane is parallel to a tangent plane of the portion of the inner surface of the window 104 within an angle of tolerance less than or equal to 20 degrees. In some implementations, the angle of tolerance can be less than or equal to 10 degrees. In this example, the surface of the photonic integrated circuit 102 is depicted to be substantially parallel to the tangent plane of the portion of the inner surface of the window 104. The aperture 106 is associated with a field of view 108 and has an associated area. In this example, the field of view 108 spans about −15° to 15°. A coating 110 is formed on a portion of the outer surface of the window 104 and an area of the coating 110 is less than twice the area of the aperture 106. In this example, the portion of the outer surface of the window 104 on which the coating 110 is formed is in proximity to the portion of the inner surface of the window 104 on which the photonic integrated circuit 102 is mounted.

Without using the methods disclosed herein, some LiDAR systems can comprise a vertically mounted aperture and utilize bulk optics for steering to enable a field of view. In some systems, the physical footprint of these bulk optics can result in an aperture being placed further away from a window such that an area of a projection of the aperture onto the window is increased. Other factors can also influence an area of an aperture projection, for instance, a curvature of a surface of a window or a casing of a LiDAR system. This increased size of projection can also increase an area of a coating applied to the window. FIG. 1B depicts a perspective view of an example configuration 100B comprising an aperture 116 and a projection 112 of the aperture 116 on a window (not shown). In this example, the aperture 116 is vertically mounted. In some examples, the projection 112 can also be referred to as an “output window.” In some examples, the aperture 116 can also be positioned further away from the window due to bulk optics and casing of a LiDAR system, which can further increase the projection, or output window size. The field of view associated with the aperture 116 in this example is −15° to 15° in vertical direction and −60° to 60° in horizontal direction.

FIG. 1C depicts a perspective view of the example configuration 100A depicted in FIG. 1A. As shown in FIG. 1C, the coating 110 has an area that is similar to an area of the projection of the aperture 106 on the window 104. In some examples, the coating 110 can comprise an anti-reflective coating. Some anti-reflective coatings can comprise one or more layers of material configured to reduce reflections associated with emission and detection of optical waves by the LiDAR system. In some examples, an anti-reflective coating (AR) can comprise one or more layers of materials configured to reduce reflections from the outer surface of the window. Some anti-reflective coatings can be formed by processes comprising material deposition or structuring. For example, a layer of the material of which the window 104 is composed (e.g., glass) can be structured to form a nanostructured layer of the material (also referred to as a nano-textured layer). In some examples, nano-textured layers can be used or applied to a window when an emission angle of a beam from a PIC relative to a vertical axis is large, such as greater than 50°, to reduce a loss associated with reflection of an optical beam. The field of view 108 can be −15° to 15° in the vertical direction and −60° to 60° in the horizontal direction, which can be close to human eye-sight.

FIG. 1D depicts a side view of a portion of an example configuration 100D. In this example, a PIC 120 comprising an aperture 122 is mounted to a surface of a window 124. As shown in FIG. 1D, a plane 126 associated with a surface of the PIC 120 and a plane 128 associated with a surface of the window 124 form an angle 130, i.e., an angle of tolerance. In some examples, this angle of tolerance can be less than or equal to 20 degrees. In some implementations, the angle of tolerance can be less than or equal to 10 degrees. An angle of tolerance can be associated with factors such as a surface flatness of a window and/or a PIC, and thicknesses of materials between the surface of the PIC and the surface of the window. In some implementations, reducing the angle 130 can be associated with less material of a coating formed on an outer surface of the window, as described in more detail later.

Some windows can be angled relative to a direction of travel associated with a vehicle. Some windows can be configured as a windshield of a vehicle such that the window is at the front of the vehicle. In some examples, an angle associated with a window or windshield can be measured with respect to the ground and can range from 15° or less to 90°. For instance, some streamline-designed vehicles can comprise a window or windshield forming an angle of 30° or less with respect to the ground while some larger vehicles such buses or trucks can comprise a windshield forming an angle of 90° with respect to the ground. Alternatively, an angle of a windshield or window can be measured with respect to a line that is perpendicular to the ground, i.e., a vertical line. Such angles can be referred to as a windshield tilt angle. For example, some streamline-designed vehicles can comprise windshield tilt angles of 75° or less with respect to a vertical line while some larger vehicles can comprise windshield tile angles of 0° with respect to a vertical line. In some implementations, if the window is positioned on a vehicle as a front window, the angle of the window is configured with respect to a corresponding forward direction of travel. Alternatively, if the window is positioned as a side window, a rear window, or a top window, for example, the window is configured with respect to a different corresponding direction of travel based on that position of the window.

In some examples, configuring a LiDAR system can comprise calculating and comparing a projected size of an aperture at different titling angles. Without intending to be bound by theory, the following is an example of a theoretical model for illustrating features. FIG. 1E depicts a prophetic plot 100E of numerical simulations of normalized projected size of an aperture on a windshield versus the windshield tilt angle. In this case, the tilting angle is defined as the angle between the windshield and vertical line, as shown by the inset. The inset also depicts an example direction of travel 150 associated with a vehicle that comprises the windshield. The prophetic plot is calculated using an example aperture with 2:1 (width: height) aspect ratio. When the titling angle is zero, the projected aperture size is the same as the aperture size. When the titling angle gets larger, the projected aperture size also gets larger. At 50°, which is the tilting angle for some vehicles such as sedans, the projected aperture size can be close to 5 times larger than the aperture. For vehicles with a windshield tilt angle larger than 60°, the projected aperture can be about 20 times larger than the aperture.

Some apertures of a LiDAR system can comprise OPAs. In some implementations, the field of view of an OPA can be kept at a horizontal direction or any other specified direction, regardless of the tilting angle of the windshield in a specific vehicle. This field of view can be achieved by adjusting the antenna pitches in an OPA, and/or adjusting the wavelengths of the input light to enable emission at directions matching the tilting angle of the windshield. In some examples, using an OPA in this manner can be difficult to achieve using free space optical designs.

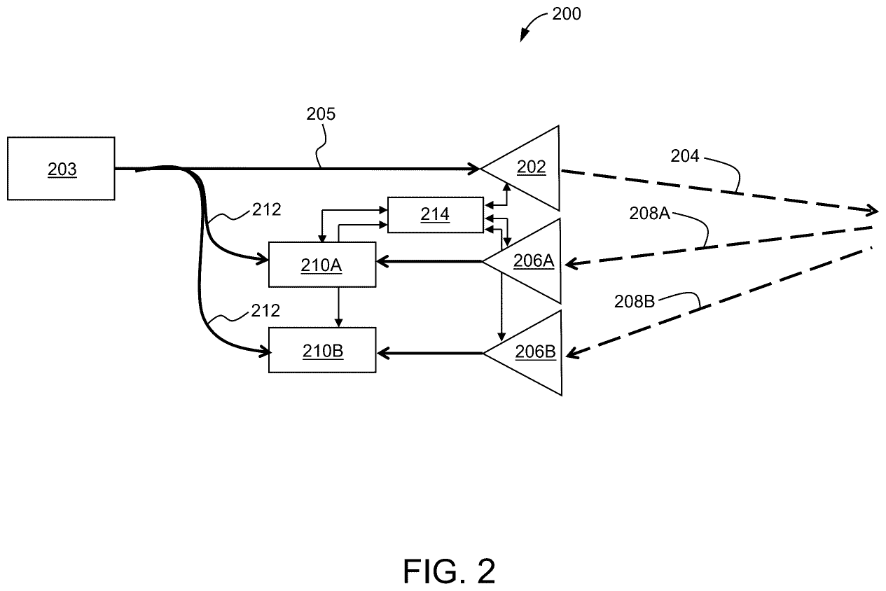

FIG. 2 shows an example of a system 200 that can be implemented as the LiDAR systems shown in FIGS. 1A-1D. In other words, the system 200 is configured as a LiDAR system. The system 200 uses a configuration that can include one or more transmitter (Tx) antenna modules and one or more receiver (Rx) antenna modules. For example, some implementations are configured to use separate Tx and Rx antenna modules, where the separate antenna modules provide a separate transmitting aperture and receiving aperture (i.e., in a bistatic arrangement). In other implementations, there is an antenna module configured to operate in both a transmitter (Tx) mode of operation and a receiver (Tx) mode of operation (i.e., in a monostatic arrangement) where the transmitting aperture and the receiving aperture are the same. In the example of FIG. 2, the system 200 includes a transmitter antenna module 202 that transmits an optical beam 204 at an angle that can be steered over a steering range. The system 200 further includes a receiver antenna module 206A and a receiver antenna module 206B that can each be controlled to receive light incoming from a particular angle (i.e., a multi-static arrangement). For example, the receiver antenna module 206A can be configured to receiving incoming light 208A including a portion of the optical beam 204 backscattered from a target object or region, and the receiver antenna module 206B can be configured to receive incoming light 208B including a portion of the optical beam 204 backscattered from the target.

The system includes an optical source 203 that provides an optical wave 205 to the transmitter antenna module 202. In some implementations, the optical source 203 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 203 is a frequency tunable laser system in which the frequency of the light provided can be swept to perform frequency modulated continuous wave (FMCW) LiDAR measurements. A coherent receiver module 210A and a coherent receiver module 210B receiving collected light from the receiver antenna module 206A and the receiver antenna module 206B, respectively, are configured to coherently mix the collected light with light of a local oscillator 212, sometimes abbreviated LO, which can be derived from the optical source 203 or from a portion of the optical wave 205 provided to the transmitter antenna module 202. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal.

A control module 214 is configured to control various aspects of the antenna modules and coherent receiver modules to determine information about a target object associated with a detection event based at least in part on one or more characteristics of the received backscattered light. In addition to a location of a target object that has backscattered light, there may also be range information characterizing a distance to the target object, and/or velocity information characterizing a relative speed of the target object, that can be obtained based at least in part on a frequency chirp (e.g., a linear chirp) that is applied to the optical wave 205 generated by the optical source 203. The control module 214 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

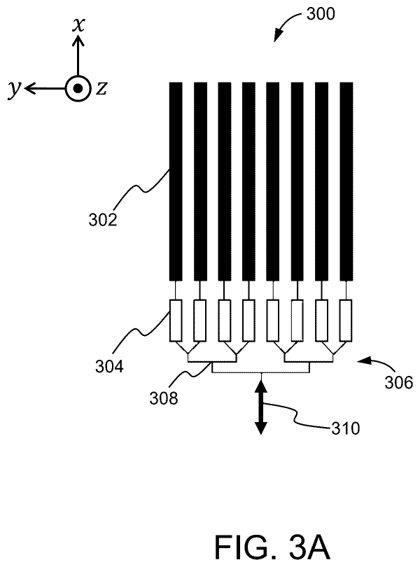

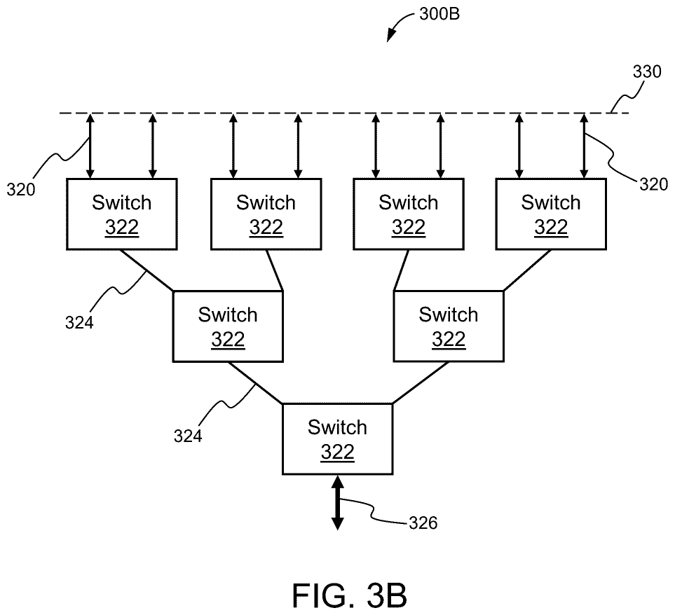

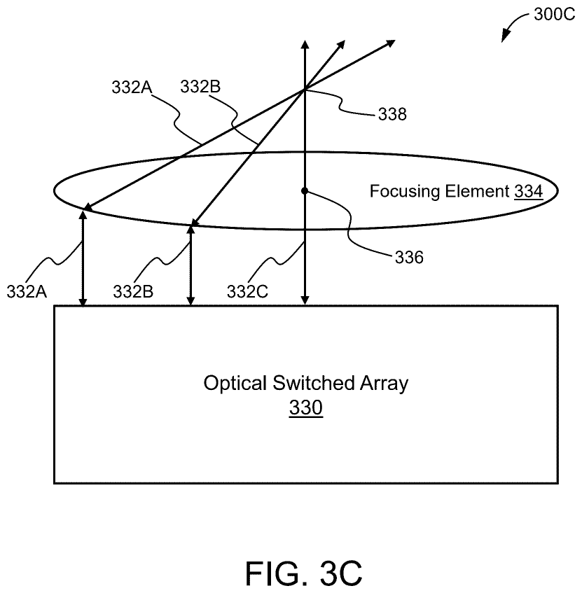

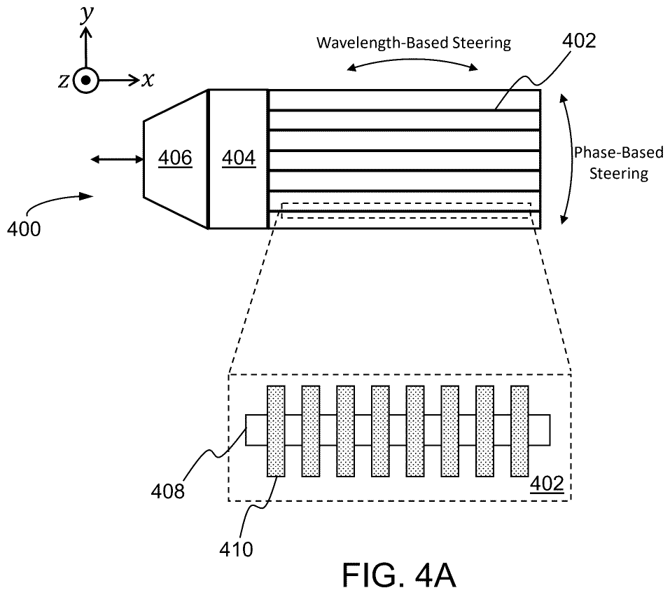

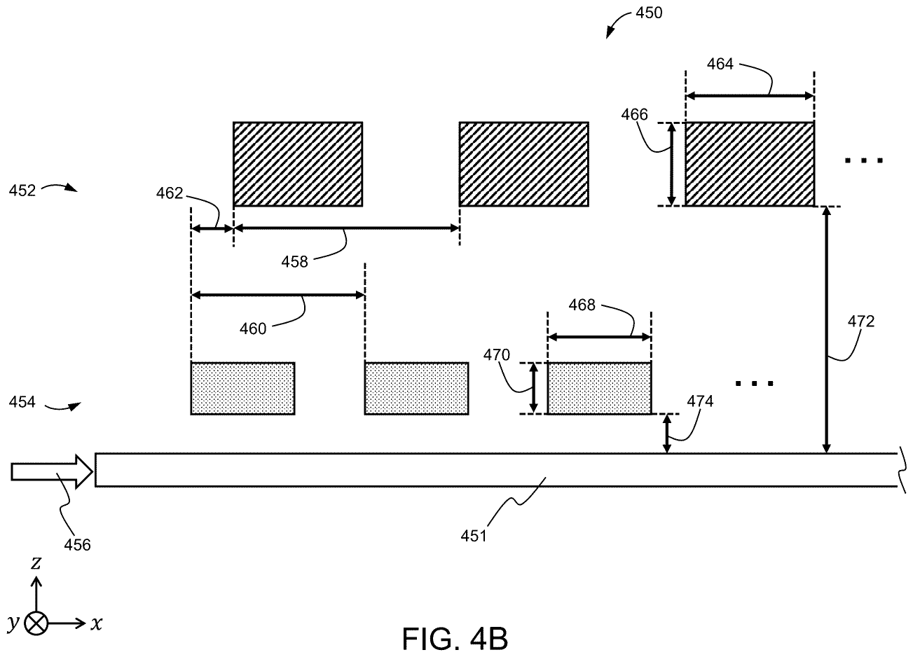

Any of a variety of techniques can be used to steer the transmission angle of the optical beam 204 provided by the transmitter antenna module 202 over a steering range, and to steer the reception angle of the receiver antenna module 206A and the receiver antenna module 206B. In some implementations, an OPA is used to enable steering of a lobe of a radiation intensity pattern (also referred to as a gain pattern) associated with the OPA. Some OPAs have a linear distribution of optical antennas. Steering about a first axis perpendicular to the linear distribution can be provided, for example, by changing the relative phase shifts in phase shifters coupled to each of the optical antennas. For example, FIG. 3A shows an example OPA 300 that includes optical antennas 302 arranged in an array. Light can be emitted from (and/or received into) optical antennas 302 from different emission planes depending on the type of optical antennas being used. For a grating-antenna-based OPA, each optical antenna is configured as an optical grating, as described in more detail in FIG. 4A, and power from individual optical waves is emitted gradually over the length of the optical gratings over an emission plane in the plane of the page in FIG. 3A (the x-y plane). Alternatively, for an end-fire-antenna-based OPA, each optical antenna is configured to emit light from the ends of the optical antennas at an emission plane that is perpendicular to the plane of the page in FIG. 3A (the y-z plane). In either case, the optical waves optically interfere with each other starting at the emission plane to form an optical phased array output beam when the OPA 300 is used as a transmitter. The direction of peak constructive interference depends on the relative phase shifts imposed on light entering the optical antennas.

The OPA 300 includes an array of optical phase shifters 304 that impose respective phase shifts on optical waves provided as phase shifted optical waves entering each optical antenna of the optical antennas 302 when the OPA is used as a transmitter, or on optical waves that have been collected by the optical antennas 302 when the OPA is used as a receiver. The optical phase shifters 304 can be, for example, electro-optic, thermal, liquid crystal, pn junction phase shifters. In some examples, each optical phase shifter of the optical phase shifters 304 is controlled independently, while in other examples two or more optical phase shifters of the optical phase shifters 304 may be jointly controlled. An optical coupler 306 is configured to couple an optical port 310 to the array of optical phase shifters 304. In this example, the optical coupler 306 is in the form of a power splitting network formed from power splitters 308 that are interconnected. In this example, the power splitters 308 are 1×2 power splitters (also referred to as 50/50 power splitters) and are interconnected by waveguides in a binary tree arrangement to achieve substantially equal power into each optical phase shifter of the optical phase shifters 304 from an input optical wave entering the optical port 310 when the OPA 300 is used as a transmitter (Tx operation), and to provide substantially equal path lengths between each optical phase shifter of the optical phase shifters 304 and the optical port 310. When the OPA 300 is used as a receiver (Rx operation), the light received by the optical antennas 302 and phase shifted by the optical phase shifters 304 is combined into an output optical wave at the optical port 310, which can then be further manipulated, transformed, or measured.

FIG. 3B shows an optical switched array 300B comprising an array of optical antennas 320 (e.g., waveguide facets in an end-fire configuration, optical gratings, plasmonic emitters, metal antennas, and mirror facets). The optical switched array 300B is arranged in a tree-like structure comprising a plurality of optical switches 322 (e.g., Mach-Zehnder interferometers) and optically interconnected via waveguides 324, i.e., a set of waveguides. The plurality of optical switches 322 may be controlled in response to one or more applied voltages, allowing the plurality of optical switches 322 to direct light at a first switch port to a second switch port and a third switch port in a tunable ratio (e.g., 50/50, 33/67, 25/75). Accordingly, the plurality of optical switches 322 can be configured (e.g., by applied voltages) to open select optical pathways between an optical port 326 and the array of optical antennas 320. For example, by applying suitable (possibly time-varying) voltages, the optical switched array 300B can provide light (e.g., emitted from a laser) from the optical port 326 to one or more of the optical antennas 320. In another example, by applying suitable voltages, the optical switched array 300B can provide light received by one or more of the optical antennas 320 to the optical port 326. In an example that uses an end-fire configuration, light is transmitted from or received into the optical antennas 320 at facets distributed over an edge along which the optical antennas 320 are arranged. In general, each optical switch of the plurality of optical switches 322 may have slightly different voltage requirements for power switching between their ports. Furthermore, one or more optical switches of the plurality of optical switches 322 may be electrically interconnected to allow for joint voltage control, possibly reducing the number of voltage sources used.

Referring again to FIG. 3B, each optical switch the plurality of optical switches 322 is configured in a 1×2 arrangement, however, other arrangements (e.g., 1×3, 1×4, 2×2, or 2×3) and mixtures of arrangements may also be utilized. The one or more switch types in an optical switched array need not all be of the same type or of the same technology (e.g., thermo-optic or electro-optic switches). A portion or all of the optical switched array 300B may be formed as part of a PIC.

FIG. 3C shows an example optical switched array system 300C that performs 1D-beam-steering. An optical switched array 330 (e.g., the optical switched array 300B shown in FIG. 3B) can selectively output a first optical beam 332A, a second optical beam 332B, and/or a third optical beam 332C. In general, the optical switched array 330 can output many optical beams. Each optical beam traverses a focusing element 334 (e.g., a lens) that converts a lateral displacement between the optical beam and a center of the focusing element 336 into an angular displacement. In this example, each optical beam orthogonal to the surface of the focusing element 336 intersects at a point 338 (e.g., a focus of a lens). For example, the first optical beam 332A has a larger lateral displacement from the center of the focusing element 336 than the second optical beam 332B, resulting in the first optical beam 332A having a larger angular displacement (with respect to its optical path prior to traversing the focusing element 334) than the second optical beam 332B. Since the third optical beam 332C is orthogonal to the surface of the focusing element 334 and has no lateral displacement from the center of the focusing element 336, the third optical beam 332C has no angular displacement.

FIG. 4A shows a top view of an example of a grating-antenna-based OPA 400 that is configured for phase-based steering about the x axis and wavelength-based steering about the y axis. For example, when configured for Tx operation, optical waves propagate along each optical grating antenna 402 of the optical grating antennas (along the x axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters (PSs) in PS module 404 and the steering in the other angular direction being performed by wavelength of an optical wave distributing optical power via an optical coupler 406. The adjustment of the transmission angle for the Tx operation and collection angle for the Rx operation in the phase-controlled angular direction can be dynamically performed as the phases imposed by the phase shifters in the PS module 404 can be quickly tuned. Each optical grating antenna 402 is formed from a waveguide 408 and grating elements 410 arranged periodically along the waveguide 408 with a particular pitch p1 (e.g., a constant spacing between grating elements 410) to perturb the guided optical wave causing emission in the direction of the grating elements 410. In some examples, the grating elements 410 can also be referred to as antenna elements or optical antenna elements. The angle at which the light is emitted from each optical grating antenna 402 depends on a relationship between the pitch p1 and the wavelength, and thus can be steered by changing the wavelength.

The PS module 404 can also be configured to provide focusing. For example, the emitted light can have a nonlinear phase front imposed on it by the phase shifters in the PS module 404 for focusing in Tx operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an end-fire optical antenna is used.

FIG. 4B shows a side view of a portion of an example optical grating antenna 450 that can be included as an optical grating antenna 402 of the grating-antenna-based OPA 400. In this example, the optical grating antenna 450 comprises a multi-layer antenna structure comprising a first plurality of optical antenna elements 452 and a second plurality of optical antenna elements 454 arranged along a waveguide 451. In this example, the first plurality of optical antenna elements 452 is formed in a first layer and the second plurality of optical antenna elements 454 is formed in a second layer that is different than the first layer. The first plurality of optical antenna elements 452 and the second plurality of optical antenna elements 454 are configured to perturb optical waves propagating in the waveguide 451 such that the grating-antenna-based OPA 400 can be configured to transmit a beam to and/or receive a beam from a target location. In some examples, the grating-antenna-based OPA 400 can be configured to receive a beam from a target location such that the first plurality of optical antenna elements 452 and the second plurality of optical antenna elements 454 couple an optical beam into the waveguide 451. In other words, a grating-antenna-based OPA can be configured to couple between an optical beam propagating in free space and an optical beam propagating in an optical waveguiding structure or optical waveguide. FIG. 4B also depicts light 456 being coupled into the waveguide 451. The emission angle of an OPA can be tuned by adjusting the wavelength of the input light, or by adjusting the pitch of the antenna in the design phase.

Without using the methods disclosed herein and using a single emitting layer, up to 50% of the optical power may be lost due to light emission occurring in both an upward and downward direction, in this case, along the +z axis and the-z axis. By including multiple emitting layers, the amount of optical power emitted in the desired direction can be increased. For instance, a desired direction can be along the +z axis.

In some examples, each of the first plurality of optical antenna elements 452 and the second plurality of optical antenna elements 454 can be fine-tuned to break the symmetry of the system to reduce back-reflected light and increase efficiency of the system. Each of the first plurality of optical antenna elements 452 and the second plurality of optical antenna elements 454 can be associated with a grating period, or a periodic interval at which the optical antenna elements are spaced. By way of example, FIG. 4B depicts a period 458 associated with the first plurality of optical antenna elements 452 and a period 460 associated with the second plurality of optical antenna elements 454. An axis associated with the period 458 and the period 460 is parallel to a direction of propagation associated with an optical wave propagating in the waveguide 451. A spacing of optical antenna elements can also be described in terms of a pitch, or a distance between adjacent optical antenna elements. Some fine tuning of the optical antenna elements can comprise tuning a grating period of each layer such that the grating periods are the same or different. In some implementations, the optical antenna elements of each layer may be offset from each other by some distance. By way of example, FIG. 4B depicts an offset 462 between the first plurality of optical antenna elements 452 and the second plurality of optical antenna elements 454.

Optical characteristics associated with a grating array, i.e., a direction that light is emitted or an optical power that is emitted, can also be tuned using other characteristics of optical antenna elements. For instance, optical characteristics of a grating antenna can be tuned by varying distances between a plurality of optical antenna elements and a waveguide, an offset between optical antenna elements in each layer of optical antenna elements, and/or dimensions of optical antenna elements.

By way of example, FIG. 4B depicts an optical antenna element of the first plurality of optical antenna elements 452 having a first dimension 464 and a second dimension 466. In this example, the first dimension 464 is along a first axis, i.e., an axis parallel to the x-axis, and the second dimension 466 is along a second axis that is perpendicular to the first axis, i.e., an axis parallel to the z-axis. The first axis is parallel to a direction of propagation associated with an optical wave propagating in the waveguide 451. An optical antenna element of the second plurality of optical antenna elements 454 has a first dimension 468 along a third axis, i.e., an axis parallel to the x-axis, and a second dimension 470 along a fourth axis, i.e., an axis parallel to the z-axis. Each of the first dimension 464 and the first dimension 468 can be referred to as a “length” of an optical antenna element while each of the second dimension 466 and the second dimension 470 can be referred to as a “thickness” of an optical antenna element.

In some implementations, the optical antenna elements of the first plurality of optical antenna elements 452 can have a length that is different from a length of the optical antenna elements of the second plurality of optical antenna elements 454. Such implementations can allow for certain optical wavelengths to be transmitted/received and can be associated with a coupling efficiency for transmitted or received optical waves.

In some implementations, other layers can be included. For instance, additional layers (not shown) can be between the first plurality of optical antenna elements 452 and the second plurality of optical antenna elements 454. Alternatively, additional layers between the first plurality of optical antenna elements 452 and the second plurality of optical antenna elements 454 can be omitted. In some examples, a layer can be placed below the waveguide 451 to direct optical waves in an upward direction.

In some implementations, the intensity of light guided by a waveguide can decrease as a function of distance from the waveguide. The optical power emitted from a waveguide grating array or coupled into a waveguide of a grating array can depend on heights of optical antenna elements relative to a waveguide or thicknesses of the optical antenna elements themselves. In some implementations, layers between the first plurality of optical antenna elements 452, the second plurality of optical antenna elements 454, and the waveguide 408 can vary a distance between the optical antenna elements and the waveguide. By way of example, FIG. 4B depicts a height 472 of the first plurality of optical antenna elements 452 relative to the waveguide 451 and a height 474 of the second plurality of optical antenna elements 454 relative to the waveguide 451. In other words, neither of the first plurality of optical antenna elements 452 and the second plurality of optical antenna elements 454 are in contact with the waveguide 451. The second dimension 466 can be different from the second dimension 470. For instance, the second dimension 466 can be greater than the second dimension 470, which can result in the first plurality of optical antenna elements 452 perturbing light guided by the waveguide 451 with the same strength as the second plurality of optical antenna elements 454.

In some examples, the waveguide 408 can comprise materials that are associated with a refractive index, i.e., poly-silicon, intrinsic silicon, doped silicon, or silicon nitride. In some examples, each of the first plurality of optical antenna elements 452, and the second plurality of optical antenna elements 454 can comprise materials such as poly-silicon, intrinsic silicon, doped silicon, silicon nitride, liquid crystals, aluminum nitride, indium titanium oxide, a metal, or germanium. In some examples, each of the waveguide 408, first plurality of optical antenna elements 452, and the second plurality of optical antenna elements 454 can be embedded in a material that is associated with a different refractive index, i.e., oxide.

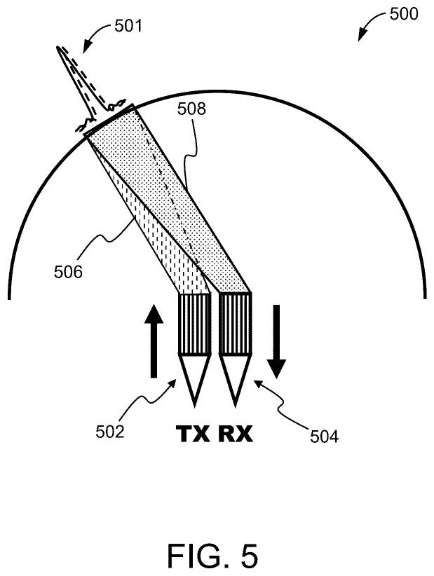

FIG. 5 shows an example LiDAR system 500 producing radiation intensity patterns 501 associated with a transmitter OPA 502 and a receiver OPA 504. In this example, main lobes associated with a transmitter radiation pattern 506 and a receiver radiation pattern 508 overlap. Such an arrangement of main lobe overlap can result, for example, from tuning phase shifters associated with transmitter and receiver optical antennas in the respective OPAs. Backscattered light from a target object situated near the main lobes is received by the receiver OPA 504. In each radiation intensity pattern, there may be a main lobe and additional grating lobes that occur on each side of the main lobe due to the limit in how close adjacent optical antennas can be in an OPA, which may limit the phase-based angular tuning range. In some implementations, the examples described herein may be designed to operate over a predetermined range of optical wavelengths such as, for example, the λ=1500 to 1600 nm band or the λ=1270 to 1330 nm band, and the pitch p corresponding to a distance between adjacent optical antennas may be of similar magnitude to the optical wavelength to increase the spacing between grating lobes (and thereby increase tuning range), or in some cases less than half of the optical wavelength to avoid grating lobes. For example, for operation in the 1500 to 1600 nm band, 700 nm ≤p≤4000 nm may be typical.

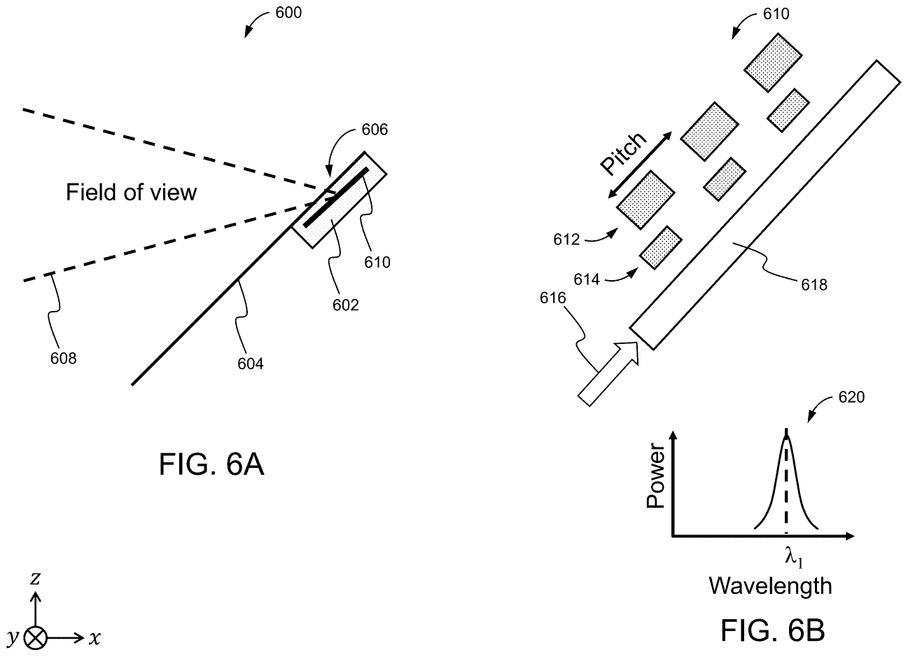

FIGS. 6A-6B, FIGS. 7A-7B, and FIGS. 8A-8B depict examples of LiDAR systems and windows of varying tilt angle. As shown in these figures, the nominal emission angle, or field of view, of an aperture can be achieved by adjusting the pitch of antenna elements of an OPA to match a tilting angle.

FIG. 6A depicts an example configuration 600 of a LiDAR system. The configuration 600 comprises a photonic integrated circuit 602 mounted to a portion of an inner surface of a window 604. The window 604 has a tilt angle relative to the vertical axis, in this example, the y-axis. The photonic integrated circuit 602 comprises an aperture 606 and is associated with a field of view 608. The photonic integrated circuit 602 also comprises an OPA 610 comprising antenna elements with a pitch configured to direct the field of view 608. In this example, the field of view 608 has a center that is less than 70 degrees relative to the photonic integrated circuit 602. As shown in FIG. 6A, the photonic integrated circuit 602 is mounted such that a surface of the photonic integrated circuit 602 that is coplanar with a first plane is parallel to a tangent plane of the inner surface of the window 604 within an angle of tolerance. In this example, the tangent plane is coplanar with the window 604 and the angle of tolerance is 0 degrees, i.e., the first plane and the tangent plane are parallel. In other implementations, the angle of tolerance can be less than or equal to 20 degrees.

FIG. 6B depicts a side view of an example OPA 610 of the photonic integrated circuit 602. The OPA 610 comprises a first set of optical antenna elements 612 formed at a first layer of the photonic integrated circuit 602 and a second set of optical antenna elements 614 formed at a second layer of the photonic integrated circuit 602 that is different than the first layer. An optical wave 616 injected into the waveguide 618 can be perturbed by the first set of optical antenna elements 612 and the second set of optical antenna elements 614. An optical wave can also be referred to as “light.” This perturbation can allow the OPA 610 to transmit a beam to, or receive a beam from, a target location through the aperture 606 in the field of view 608. An example wavelength spectrum 620 associated with the optical wave 616 is also shown in FIG. 6B. In this example, the wavelength of the optical wave 616 is centered at λ1. A coating (not shown) can also be applied to a portion of an outer surface of the window 604 that is in proximity to the photonic integrated circuit 602.

The window 604 shown in FIG. 6A can be a component of a vehicle, which can be associated with a direction of travel. In this example, the direction of travel of the vehicle can be along the -x axis such that the field of view 608 has a center that is less than 20 degrees relative to the direction of travel.

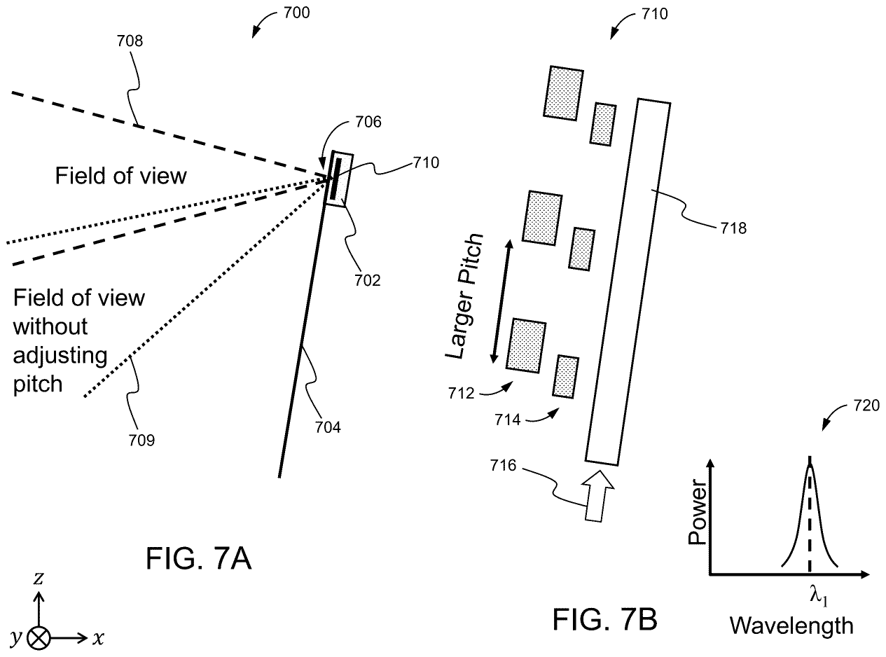

FIG. 7A depicts an example configuration 700 comprising a photonic integrated circuit 702 mounted to a window 704 having a smaller tilt angle than the window 604 depicted in FIG. 6A. The photonic integrated circuit 702 comprises an aperture 706 and is associated with a field of view 708. The photonic integrated circuit 702 also comprises an OPA 710, a side view of which is depicted in FIG. 7B. The OPA 710 comprises a first set of optical antenna elements 712 and a second set of optical antenna elements 714 that are configured to direct the field of view 708. A second field of view 709 associated with a different pitch of optical antenna elements is also shown in FIG. 7A. By adjusting the pitch of the first set of optical antenna elements 712 and the second set of optical antenna elements 714, the field of view can be angled relative to the photonic integrated circuit 702, as demonstrated by the field of view 708 and the second field of view 709. Referring back to FIG. 7B, an optical wave 716 is injected into the waveguide 718 and is perturbed by the first set of optical antenna elements 712 and the second set of optical antenna elements 714 such that the photonic integrated circuit 702 is configured to transmit a beam to or receive a beam from a location within the field of view 708. An example wavelength spectrum 720 associated with the optical wave 716 is also shown. In this example, the wavelength of the optical wave 716 is centered at λ₁.

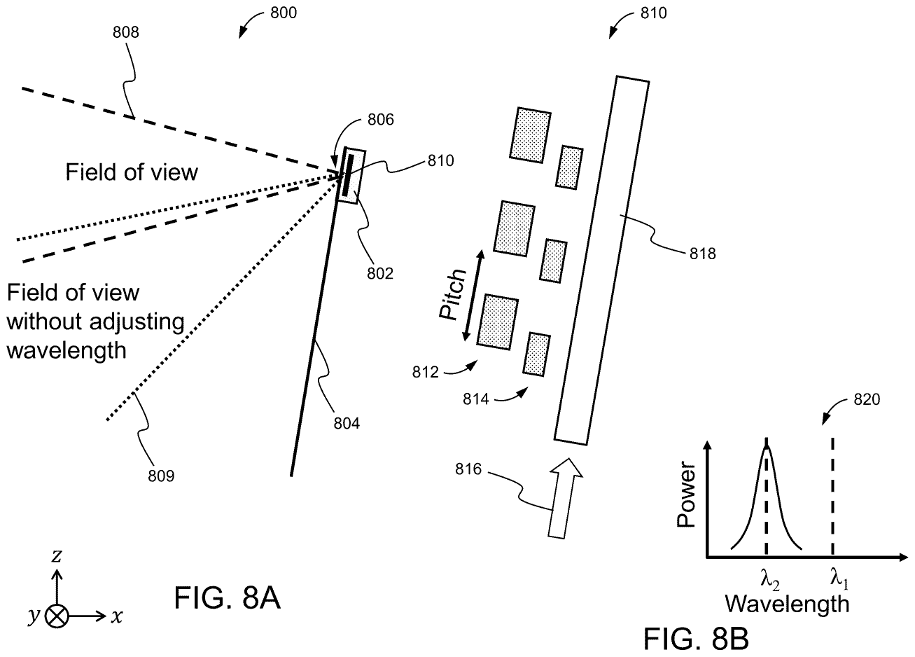

An alternative way to adjust the emission angle is to change the wavelength of the emitted light. In some examples, this wavelength shift can be accomplished by switching to a laser with a shorter wavelength band. FIG. 8A depicts an example configuration 800 comprising a photonic integrated circuit 802 mounted to a window 804 having a smaller tilt angle than the window 604 depicted in FIG. 6A. The photonic integrated circuit 802 comprises an aperture 806 and is associated with a field of view 808. The photonic integrated circuit 802 further comprises an OPA 810 comprising a first set of optical antenna elements 812 and a second set of optical antenna elements 814 with a pitch similar to the OPA 610 depicted in FIG. 6B. A second field of view 809 associated with a different pitch of optical antenna elements is also shown. FIG. 8B depicts a side view of the OPA 810. An optical wave 816 is injected into the waveguide 818 and propagates from the optical antenna elements. An example wavelength spectrum 820 associated with the optical wave 816 is also shown. In this example, the wavelength of the optical wave 816 is centered at λ₂, which is lower than the wavelength λ₁ of the optical wave 616 and the optical wave 716. In this example, using a different wavelength allows the OPA 810 to achieve the field of view 808 rather than the field of view 809. In this way, the wavelength of the optical wave 816 compensates for the pitch of the antenna elements of the OPA 810 and the tilt of the window 804.

Optical antenna element pitch adjustment and wavelength switching can be combined for ease of implementation in specific applications. In some examples, mounting an OPA to a window can comprise minimizing an output aperture of the OPA on the window. In some examples, optical waves or light can also be injected from different directions into an OPA.

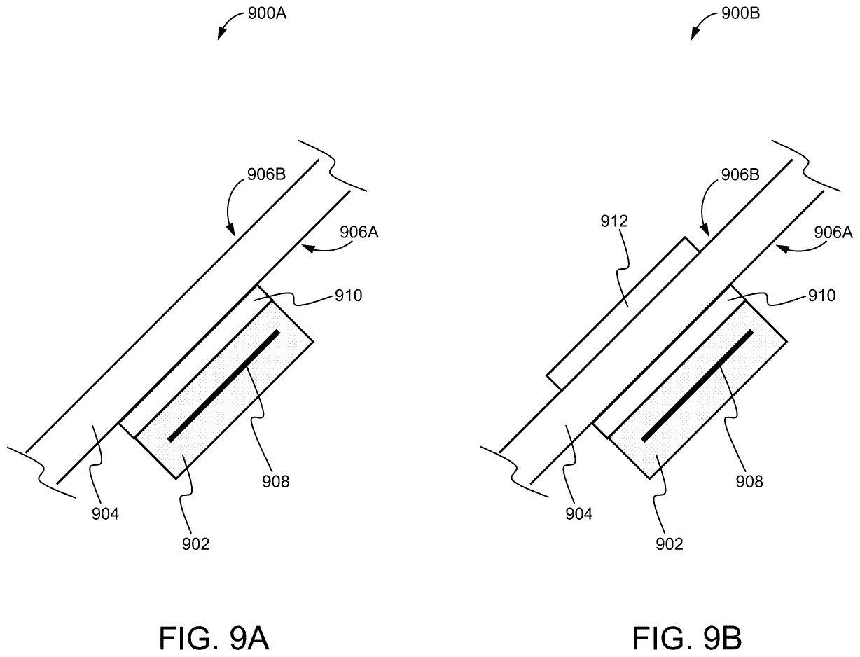

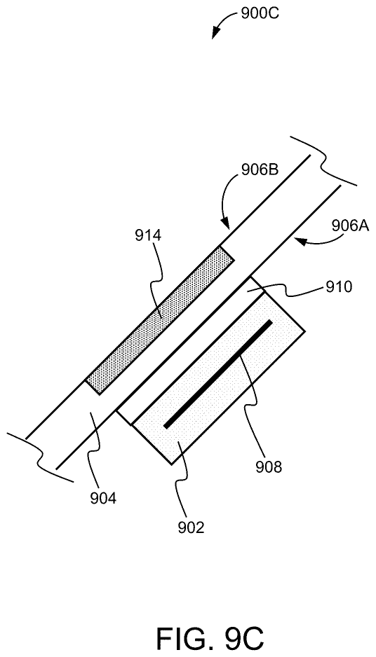

In some implementations, methods can be utilized to reduce a reflection of an optical beam by surfaces of a window or a top surface of a photonic integrated circuit. For instance, one or more layers of material can be included between a surface of a photonic integrated circuit and a portion of a surface of a window to which the photonic integrated circuit is mounted. FIG. 9A depicts a side view of an example configuration 900A comprising a photonic integrated circuit 902 mounted to a portion of a window 904. As shown in FIG. 9A, the window 904 comprises a first surface 906A, i.e., an inner surface, and a second surface 906B, i.e., an outer surface. In other words, the photonic integrated circuit 902 is mounted to a portion of the first surface 906A of the window 904. The photonic integrated circuit 902 comprises an optical aperture 908. One or more layers 910 of material are positioned between a portion of the first surface 906A and the photonic integrated circuit 902.

In some examples, the one or more layers between a surface of a window and a photonic integrated circuit can comprise an index-matching material. Some index-matching materials can have an index of refraction that matches an index of refraction of a window and/or a PIC within 10%.

Alternatively, AR layers or coatings can be formed on an inner surface of a window, an outer surface of a window, and/or a surface of a PIC to reduce reflection. In some examples, AR coatings can comprise one or more layers of material, i.e., a nanostructured layer also referred to as a nano-textured layer. In some implementations, one or more layers of material, such as a dielectric material or a nanostructured material, can be deposited on a window to form a coating. Some nanostructured coatings can be applied to a surface of a window and/or a PIC when an emission angle of an optical beam from the PIC relative to a vertical axis of the window is large, such as greater than 50°, to reduce the loss from reflection. In some examples, internal or external prisms can be applied to a PIC to slightly adjust an emission angle of a beam from the PIC to reduce loss from large angle emissions.

FIG. 9B depicts an example configuration 900B. In this example, one or more layers 912 of material are included on the second surface 906B of the window 904. In some examples, these one or more layers 912 can be configured as an AR coating.

In some examples, the material of a window itself can be nanostructured such that the one or more layers of material forming the AR coating comprise at least one nanostructured layer of a portion of an outer surface of a window. FIG. 9C depicts a side view of an example configuration 900C in which a portion 914 of the window 904 is nanostructured.

Some windows can be a component of a vehicle. Some windows can be a front window of a vehicle such that the window is a windshield. Some vehicles can be land vehicles, aircraft, watercraft, or spacecraft. In some examples, a vehicle can be selected from the group consisting of an automobile, a truck, a bus, a train, a plane, a boat, a motorcycle, a helicopter, and a spaceship.

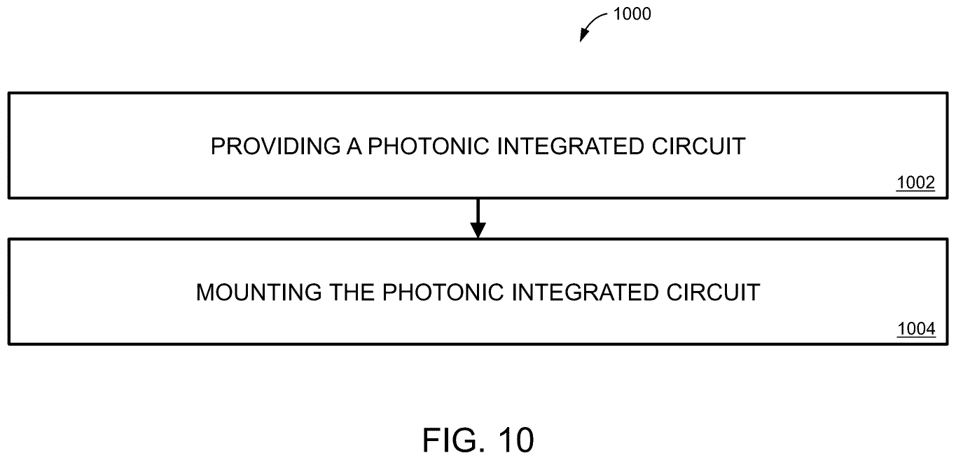

FIG. 10 depicts an example method 1000 associated with configuring window-mounted photonic integrated circuits. The method 1000 comprises providing 1002 a photonic integrated circuit. In some implementations, the photonic integrated circuit can comprise a surface that is substantially coplanar with a first plane, and an aperture in proximity to the surface, where the aperture has an associated area. The method 1000 further comprises mounting 1004 the photonic integrated circuit. In some implementations, the photonic integrated circuit can be mounted to a portion of an inner surface of a window such that the surface of the photonic integrated circuit is in proximity to a portion of the inner surface of the window and the first plane is parallel to a tangent plane of the portion of the inner surface of the window within an angle of tolerance of less than or equal to 20 degrees. In some implementations, a coating can be formed on a portion of or from a portion of an outer surface of the window such that an area of the coating is less than twice the area of the aperture.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a photonic integrated circuit comprising
a surface that is substantially coplanar with a first plane, and
an aperture in proximity to the surface, where the aperture has an associated area;
a window comprising an inner surface and an outer surface; and
a coating formed on a portion of or from a portion of the outer surface of the window, where an area of the coating is less than twice the area of the aperture;
wherein the surface of the photonic integrated circuit is mounted in proximity to a portion of the inner surface of the window such that the first plane is parallel to a tangent plane of the portion of the inner surface of the window within an angle of tolerance of less than or equal to 20 degrees.

2. The apparatus of claim 1, wherein the aperture is in proximity to a first set of optical antenna elements formed in a first layer of the photonic integrated circuit and a second set of optical antenna elements formed in a second layer of the photonic integrated circuit that is different than the first layer.

3. The apparatus of claim 2, wherein the first set of optical antenna elements and the second set of optical antenna elements are configured to perturb one or more optical waves propagating in a set of waveguides formed in the photonic integrated circuit such that an optical phased array formed in the photonic integrated circuit is configured to transmit a beam to, or receive a beam from, a target location through the aperture.

4. The apparatus of claim 3, wherein at least one of (1) a pitch of the first set of optical antenna elements and a pitch of the second set of optical antenna elements or (2) a wavelength of the one or more optical waves is configured such that the beam is steered within a field of view having a center that is less than 70 degrees relative to the first plane.

5. The apparatus of claim 1, wherein the window is a component of a vehicle.

6. The apparatus of claim 5, wherein the window is a windshield of the vehicle.

7. The apparatus of claim 5, wherein the vehicle is selected from a group consisting of an automobile, a truck, a bus, a train, a plane, and a boat.

8. The apparatus of claim 5, wherein the window is angled relative to a direction of travel associated with the vehicle such that the direction of travel is less than 70 degrees relative to the tangent plane.

9. The apparatus of claim 8, wherein the photonic integrated circuit comprises an optical phased array configured to transmit a beam to, or receive a beam from, a target location through the aperture, such that the beam is steered within a field of view having a center that is less than 20 degrees relative to the direction of travel.

10. The apparatus of claim 1, wherein the angle of tolerance is less than or equal to 10 degrees.

11. The apparatus of claim 1, further comprising an index-matching material between the surface of the photonic integrated circuit and the portion of the inner surface of the window, where the index-matching material has an index of refraction that matches an index of refraction of the window within 10%.

12. The apparatus of claim 1, wherein the coating comprises an anti-reflective coating comprising one or more layers of material configured to reduce reflections from the outer surface of the window.

13. The apparatus of claim 12, wherein the one or more layers of material comprise at least one nanostructured layer of the portion of the outer surface of the window.

14. The apparatus of claim 1, wherein the portion of the inner surface of the window is in proximity to the portion of the outer surface of the window on which the coating is formed.

15. The apparatus of claim 1, wherein at least one of: (1) the aperture is configured to transmit at least one beam of an optical wave toward a target location, or (2) the aperture is configured to receive at least one beam of an optical wave from a target location.

16. A method comprising:
providing a photonic integrated circuit comprising
a surface that is substantially coplanar with a first plane, and
an aperture in proximity to the surface, where the aperture has an associated area;
and
mounting the photonic integrated circuit to a portion of an inner surface of a window such that the surface of the photonic integrated circuit is in proximity to a portion of the inner surface of the window and the first plane is parallel to a tangent plane of the portion of the inner surface of the window within an angle of tolerance of less than or equal to 20 degrees;
wherein a coating is formed on a portion of or from a portion of an outer surface of the window such that an area of the coating is less than twice the area of the aperture.

17. The method of claim 16, wherein at least one of: (1) the aperture is configured to transmit at least one beam of an optical wave toward a target location, or (2) the aperture is configured to receive at least one beam of an optical wave from a target location.

18. The method of claim 16, wherein the angle of tolerance is less than or equal to 10 degrees.

19. The method of claim 16, wherein the aperture is in proximity to a first set of optical antenna elements formed in a first layer of the photonic integrated circuit and a second set of optical antenna elements formed in a second layer of the photonic integrated circuit that is different than the first layer.

20. The method of claim 16, wherein the window is a component of a vehicle.
